(19) United States
(12) Patent Application Publication
(10) Pub. No.: US 2025/0314088 A1
(43) Pub. Date: Oct. 9, 2025

(54) SOLAR FOUNTAIN NOZZLE AND SWIMMING POOL FOUNTAIN

(71) Applicant: Shenzhen Maining Innovation Technology Co., Ltd., Shenzhen (CN)

(72) Inventor: Huifeng HUANG, Shenzhen (CN)

(73) Assignee: Shenzhen Maining Innovation Technology Co., Ltd., Shenzhen (CN)

(21) Appl. No.: 19/240,416

(22) Filed: Jun. 17, 2025

(30) Foreign Application Priority Data
Dec. 21, 2024 (CN) 202423165290.3

(51) Int. Cl. E04H 4/14; E04H 4/12

(52) U.S. Cl. CPC E04H 4/148; E04H 4/12

(57) ABSTRACT

A solar fountain nozzle includes: a housing, where a water inlet cavity and an accommodating cavity that are independent of each other are disposed in the housing, a first end of the water inlet cavity is provided with a water inlet, a second end of the water inlet cavity is closed, a first end of the accommodating cavity is closed, a second end of the accommodating cavity is an open end, a side surface of the housing is provided with a jet, and the jet communicates with the water inlet cavity; an electronic assembly; a mounting base, where the electronic assembly is disposed on the mounting base, and is placed in the accommodating cavity along with the mounting base from the second end of the accommodating cavity; and a solar panel disposed at an upper end of the housing, where the solar panel is electrically connected to the electronic assembly.

### CROSS-REFERENCE TO RELATED APPLICATIONS

This application claims priority to Chinese Patent Application No. 202423165290.3 with a filing date of Dec. 21, 2024. The content of the aforementioned application, including any intervening amendments thereto, is incorporated herein by reference.

### TECHNICAL FIELD

The present application belongs to the field of fountain technologies, and in particular, relates to a solar fountain nozzle and a swimming pool fountain.

### BACKGROUND

A swimming pool is a dedicated facility for swimming activities or aquatic recreation. People can engage in recreational activities or competitions in the swimming pool. Due to busy work, study, etc., people usually swim not only during daylight hours but also at night. Under low-light or nighttime conditions, swimming pool lighting can provide illumination for the swimming pool, making swimmers and other aquatic activity participants engage in recreation safely, improving safety in the swinging pool, and providing good visibility.

Furthermore, to enhance user experience, users currently adopt solar fountain lighting to replace traditional ambient lighting. In this way, renewable solar energy is used, dependence on a conventional power supply is reduced, and use costs are reduced.

However, current solar fountain lighting employs a stacked design. This not only increases mounting difficulty, but also increases maintenance complexity and time. In addition, production costs are increased.

### SUMMARY

The present application provides a solar fountain nozzle and a swimming pool fountain, to resolve disadvantages in the prior art.

To resolve the technical problem, the present application provides the following technical solution. A solar fountain nozzle includes: a housing, where a water inlet cavity and an accommodating cavity that are independent from each other are defined in the housing, a first end of the water inlet cavity is provided with a water inlet, a second end of the water inlet cavity is closed, a first end of the accommodating cavity is closed, a second end of the accommodating cavity is an open end, a side surface of the housing is provided with a jet, and the jet communicates with the water inlet cavity; an electronic assembly; a mounting base, where the electronic assembly is disposed on the mounting base, and is placed in the accommodating cavity along with the mounting base from the second end of the accommodating cavity; and a solar panel disposed on an upper end of the housing, where the solar panel is electrically connected to the electronic assembly.

Further, the electronic assembly includes a battery, a main control board, and a light source module; the light source module is electrically connected to the main control board, and the main control board is electrically connected to the battery; a first mounting area, a second mounting area, and a third mounting area are provided on the mounting base, and the first mounting area is configured to accommodate the battery; the second mounting area and the third mounting area are respectively located on two sides of the first mounting area, and one end of the main control board is connected to the second mounting area; and one end of the light source module is connected to the third mounting area.

Preferably, a detecting terminal configured to detect water flow is disposed on the housing, one end of the detecting terminal is electrically connected to the main control board, and the other end of the detecting terminal extends into the water inlet cavity.

Further preferably, at least two detecting terminals are spaced at intervals between two ends of the water inlet cavity.

Specifically, a placement groove is provided at the upper end of the housing, and the solar panel is mounted in the placement groove.

Further, a wiring hole is further provided at the placement groove, and the solar panel and/or the detecting terminal are/is connected to the main control board by using a conducting wire passing through the wiring hole.

Further, a sealing cover is disposed at the second end of the accommodating cavity. The sealing cover is configured to seal the open end of the accommodating cavity.

Still further, a switch board is connected with the mounting base, the switch board is configured to allow the battery to abut against the first mounting area of the mounting base, and a switch button adaptive to the switch board is disposed on the sealing cover.

Specifically, the light source module is a light strip assembly that includes a lamp bead board and a mounting structure, where the lamp bead board is disposed on the mounting structure, and the mounting structure is fastened to the mounting base.

The present application further discloses a swimming pool fountain. The swimming pool fountain includes a water supply pipe and the solar fountain nozzle; a water inlet of the solar fountain nozzle is connected to a connector, the connector is connected to a water outlet end of the water supply pipe, and a water inlet end of the water supply pipe is configured to connect to a drainage port of a swimming pool.

The present application has the following beneficial effects: The electronic assembly and the mounting base are connected as a whole and placed in the accommodating cavity from the second end of the accommodating cavity, thereby achieving a simple structure, convenient assembly and easy daily maintenance. In addition, the detecting terminal may be configured to detect whether there is water flow in the water inlet cavity. The lamp bead board is controlled by the main control board to work only after it is detected that water flows into the water inlet cavity, and the lamp bead board is closed when there is no water flow. This saves energy consumption, and can further prevent mosquitos from dropping into the swimming pool due to phototaxis of the mosquitos.

### BRIEF DESCRIPTION OF THE DRAWINGS

The accompanying drawings are provided for further comprehension of the present application and constitute a part of the specification. The accompanying drawings, together with the embodiments of the present application, are intended to explain rather than limit the present application. In the accompanying drawings:

FIG. 1 is a structural schematic diagram showing a solar fountain nozzle according to an embodiment of the present application;

FIG. 2 is a structural exploded view showing a solar fountain nozzle according to an embodiment of the present application;

FIG. 3 is a partially enlarged view of portion A shown in FIG. 2;

FIG. 4 is an exploded view showing a housing and an electronic assembly of a solar fountain nozzle according to an embodiment of the present application;

FIG. 5 is an exploded view showing an electronic assembly and a mounting base of a solar fountain nozzle according to an embodiment of the present application;

FIG. 6 is an exploded view showing an electronic assembly and a mounting base of a solar fountain nozzle according to an embodiment of the present application from another perspective;

FIG. 7 is a schematic diagram showing a second end of an accommodating cavity of a solar fountain nozzle according to an embodiment of the present application;

FIG. 8 is a schematic diagram showing a first end of a water inlet cavity of a solar fountain nozzle according to an embodiment of the present application;

FIG. 9 is a sectional view along line B-B shown in FIG. 8; and

FIG. 10 is a structural schematic diagram showing a swimming pool fountain according to an embodiment of the present application.

Descriptions of reference numbers: 100—solar fountain nozzle; 200—water supply pipe; 300—tee joint; 1000—swimming pool fountain;
1—housing; 2—mounting base; 21—first mounting area; 22—second mounting area; 23—third mounting area; 3—solar panel; 4—battery; 5—main control board; 6—light strip assembly; 61—lamp bead board; 62—mounting structure; 7—switch board; 8—sealing cover; 9—detecting terminal; 10—connector; 11—water inlet cavity; 111—water inlet; 112—jet; 12—accommodating cavity; 13—placement groove; 14—wiring hole; and 15—light-transmitting area 15.

### DETAILED DESCRIPTION OF THE EMBODIMENTS

The preferred embodiments of the present application are described below with reference to the drawings. It should be understood that the preferred embodiments described herein are only used to illustrate the present application, rather than to limit the present application.

### Embodiment 1

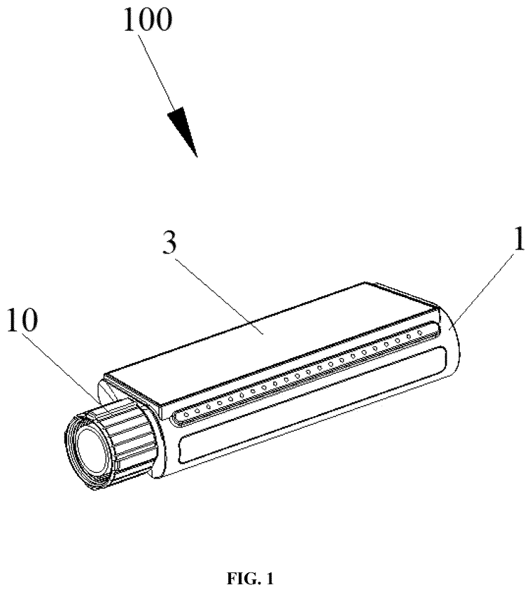

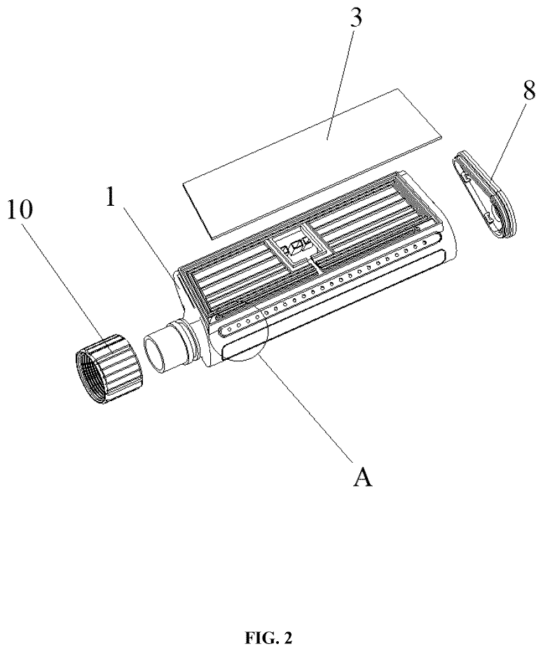

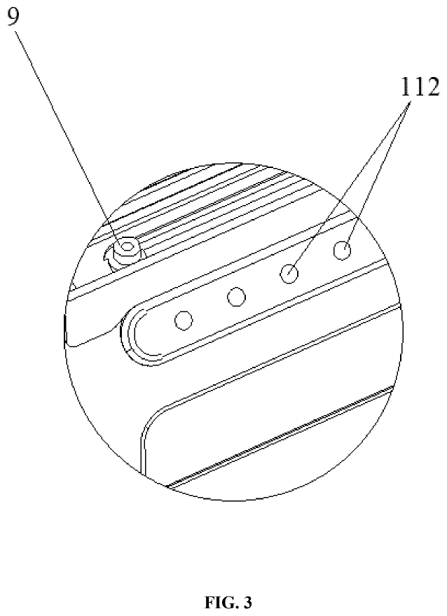

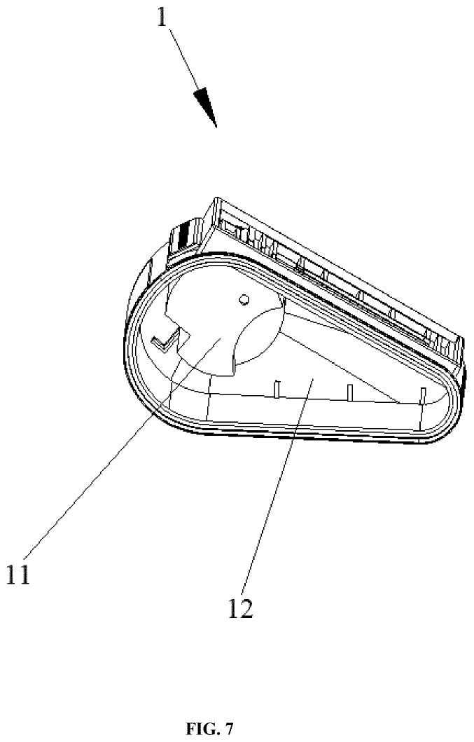

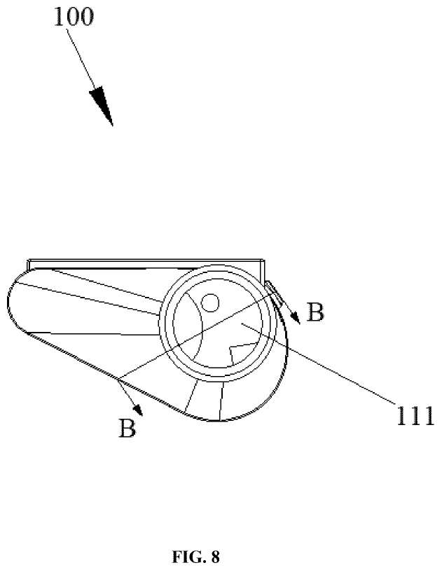

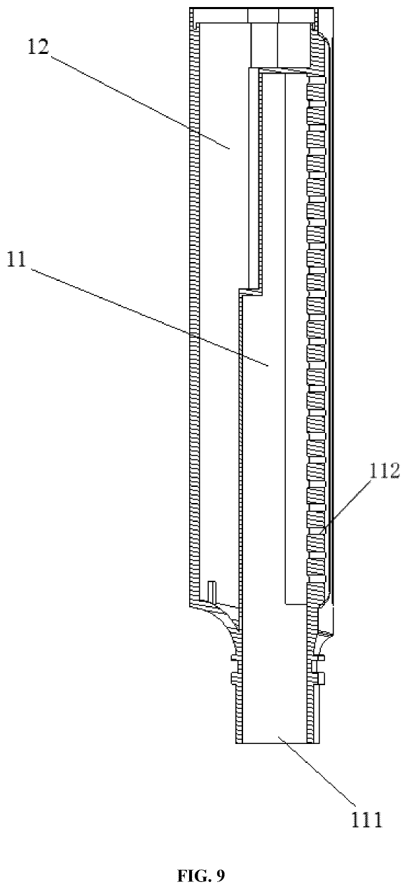

As shown in FIG. 1 to FIG. 9, a solar fountain nozzle includes a housing 1 and a solar panel 3 mounted on an upper surface of the housing 1. A water inlet cavity 11 and an accommodating cavity 12 that are independent from each other are formed in the housing 1. Both the water inlet cavity 11 and the accommodating cavity 12 extend in a length direction of the housing 1. One end of the water inlet cavity 11 is closed, and a water inlet 111 is formed at the other opposite end of the water inlet cavity 11. A plurality of jets 112 are spaced apart in the length direction of the housing 1. Each jet 112 communicates with the water inlet cavity 11. A first end of the accommodating cavity 12 is closed, and a second end of the accommodating cavity 12 is an open end. An electronic assembly is disposed in the accommodating cavity 12, and the electronic assembly is disposed on a mounting base 2. The mounting base 2 and the electronic assembly are placed in the accommodating cavity 12 from the open end of the accommodating cavity 12.

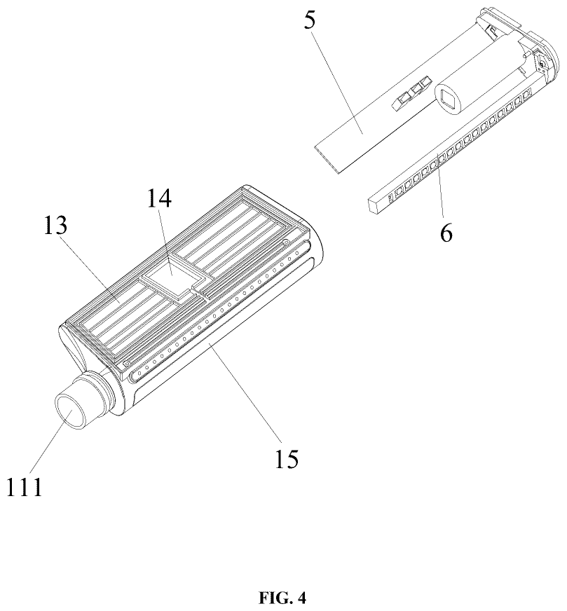

A structure of the electronic assembly is as shown in FIG. 4 to FIG. 6. The electronic assembly includes a battery 4, a main control board 5, and a light strip assembly 6. In another implementation, the light strip assembly 6 may alternatively be replaced with a light source module of another form, for example, a fluorescent lamp.

A first mounting area 21 for accommodating the battery 4, a second mounting area 22 for disposing the main control board 5, and a third mounting area 23 for disposing the light strip assembly 6 are provided on the mounting base 2. The first mounting area 21 is a cylindrical cavity, and the battery 4 is placed in the cylindrical cavity. The second mounting area 22 and the third mounting area 23 are respectively located on two sides of the cylindrical cavity that serves as the first mounting area 21. In this embodiment, the second mounting area 22 is a clamping groove, and one end of the main control board 5 is connected to the clamping groove, and is fastened by using a screw. The third mounting area 23 is a mounting plane, and an end surface of the light strip assembly 6 and the mounting plane are attached to each other, and are fastened to each other by using a screw. A peripheral contour of the mounting base 2 fits an end part of the housing 1 in shape, and a convex rib is disposed on a periphery of the mounting base 2. After being connected, the battery 4, the main control board 5, the light strip assembly 6, and the mounting base 2 are integrally disposed in the accommodating cavity 12, and the convex rib of the mounting base 2 press against an end surface of the housing 1. In addition, in this embodiment, a sealing cover 8 is mounted on an outer side of the mounting base 2, and is connected to the housing 1 in snap-fit manner. This mounting manner is simple and efficient, and therefore, mounting and difficulty steps are reduced. In addition, later maintenance is in convenient.

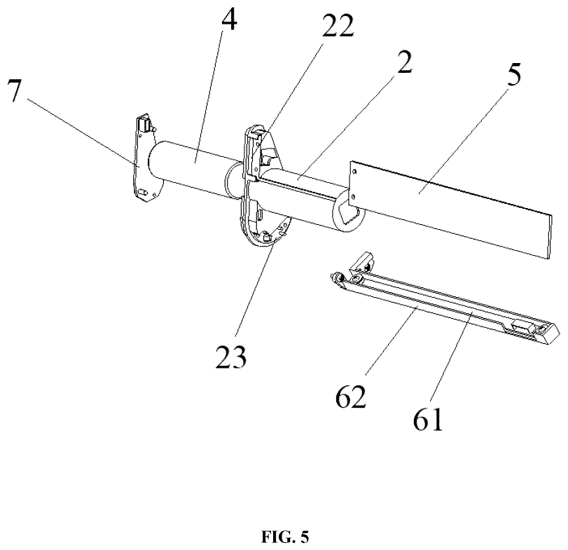

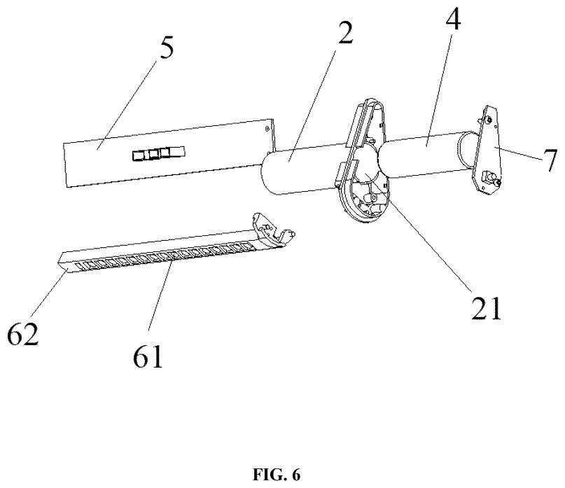

A structure of the light strip assembly 6 is as shown in FIG. 5 and FIG. 6, including the lamp bead board 61 and the mounting structure 62. The lamp bead board 61 is disposed on the mounting structure 62. One end of the mounting structure 62 is fastened to the third mounting area 23 of the mounting base 2 by using a screw. The disposed mounting structure 62 can achieve an effect of protecting the lamp bead board 61. A light-transmitting area 15 is disposed on the housing 1. A location of the light-transmitting area 15 corresponds to the lamp bead board 61, making light be emitted from the light-transmitting area 15.

As shown in FIG. 4, a placement groove 13 and a wiring hole 14 are further provided on an upper surface of the housing 1. The solar panel 3 is disposed on the placement groove 13. The solar panel 3 is electrically connected to the main control board 5 by using a conducting wire. The main control board 5 is electrically connected to the battery 4 by using a conducting wire. The light strip assembly 6 is electrically connected to the main control board 5 by using a conducting wire. A conducting wire between the solar panel 3 and the main control board 5 passes through the wiring hole 14.

In this embodiment, a plurality of detecting terminals 9 are further disposed on the housing 1. One end of the detecting terminal 9 extends into the water inlet cavity 11, and the other end of the detecting terminal 9 is electrically connected to the main control board 5 through a conducting wire, and the conducting wire passes through the wiring hole 14. A wire slot for allowing the conducting wire to lay is disposed on a surface of the housing 1, preventing the solar panel 3 from squeezing the conducting wire. In this embodiment, two detecting terminals 9 are disposed. When water enters the water inlet cavity 11 from the water inlet 111, the main control board 5 may be in a water-induced short circuit through the detecting terminals 9, to achieve a working condition for starting the lamp bead board 61. It may be understood that, in this embodiment of the present application, an effect of water flow detection is achieved by using the detecting terminal 9. A specific working principle is as follows: Water flow strength is determined by using signal strength. For example, after an external water pump starts to work, water flow enters the water inlet cavity 11. In this case, resistance between two detecting terminals 9 is reduced. When current signal strength is higher than a threshold, the light strip assembly 6 is started. When the external water pump is shut off, water flow is reduced, and the resistance between the detecting terminals 9 is increased. When the current signal strength is lower than the threshold, the light strip assembly 6 is shut off.

Preferably, the detecting terminal 9 is a spring ejector pin. A distance between the two detecting terminals 9 is set to be large. For example, the two detecting terminals 9 may be located at two ends of the water inlet cavity 11, respectively. In this way, resistance formed by the water flow between the two detecting terminals 9 is large, preventing residual water from being triggered by mistake to start the lamp bead board 61.

Further preferably, as shown in FIG. 5 and FIG. 6, a switch board 7 is further connected to an outer side of the mounting base 2. The switch board 7 can be connected to press the battery 4 against the first mounting area 21. In addition, a matched switch button (not shown in the figure) is further disposed on the sealing cover 8.

### Embodiment 2

A difference between this embodiment and Embodiment 1 lies in that, an implementation in which the water inlet cavity 11 and the accommodating cavity 12 that are independent of each other are disposed in the housing 1 is different. For example, the water inlet cavity 11 and the accommodating cavity 12 are separately designed. The water inlet cavity 11 and the accommodating cavity 12 are disposed side by side, and may be assembled together in a sliding snap-fit manner. A housing of the water inlet cavity 11 and a housing of the accommodating cavity 12 are in sliding snap-fit to form the housing 1.

### Embodiment 3

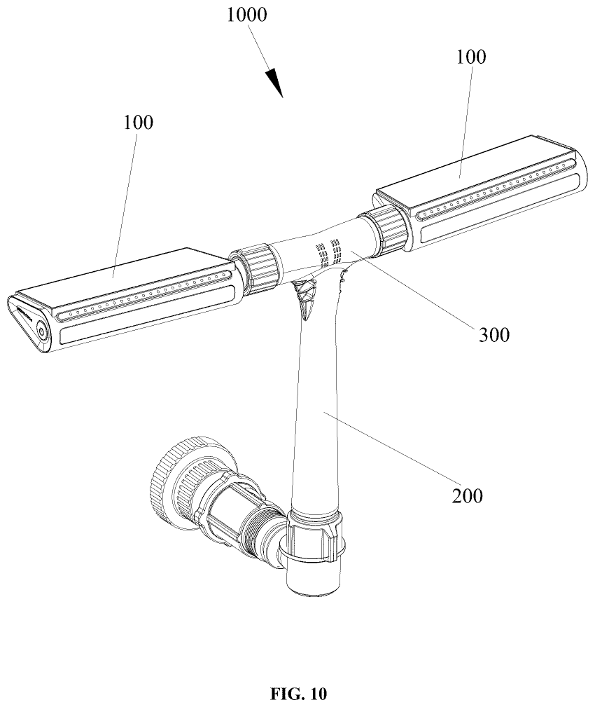

As shown in FIG. 10, the present application further provides a swimming pool fountain, including a water supply pipe 200 and the solar fountain nozzle 100 in Embodiment 1. A water inlet 111 of a water inlet cavity 11 of the solar fountain nozzle 100 is in a threaded connection to a water outlet end of the water supply pipe 200 by using a connector 10. A water inlet end of the water supply pipe 200 is connected to a drainage port on a side wall of a swimming pool. In the fountain shown in FIG. 10, the water outlet end of the water supply pipe 200 is connected to two solar fountain nozzles 100 by using a tee joint 300. In another implementation, only one solar fountain nozzle 100 may be connected.

By combining water flow with light, the swimming pool fountain 1000 can create dynamic and aesthetic visual effects at night, improving aesthetic integrity of the swimming pool.

It should be noted that, the above embodiments are merely intended to describe the technical solutions of the present application, rather than to limit the present application. It should be understood that, a person of ordinary skill in the art may still make modifications or equivalent substitutions to the specific embodiments of the present application without departing from the spirit and scope of the present application, and these modifications or equivalent substitutions shall fall within the protection scope of the claims of the present application.

What is claimed is:

1. A solar fountain nozzle, comprising:
a housing, wherein a water inlet cavity and an accommodating cavity that are independent from each other are defined in the housing, a first end of the water inlet cavity is provided with a water inlet, a second end of the water inlet cavity is closed, a first end of the accommodating cavity is closed, a second end of the accommodating cavity is an open end, a side surface of the housing is provided with a jet, and the jet communicates with the water inlet cavity;
an electronic assembly;
a mounting base, wherein the electronic assembly is disposed on the mounting base, and is placed in the accommodating cavity along with the mounting base from the second end of the accommodating cavity; and
a solar panel disposed on an upper end of the housing, wherein the solar panel is electrically connected to the electronic assembly.

2. The solar fountain nozzle according to claim 1, wherein the electronic assembly comprises a battery, a main control board, and a light source module; the light source module is electrically connected to the main control board, and the main control board is electrically connected to the battery; a first mounting area, a second mounting area, and a third mounting area are provided on the mounting base, and the first mounting area is configured to accommodate the battery; the second mounting area and the third mounting area are respectively located on two sides of the first mounting area, and one end of the main control board is connected to the second mounting area; and one end of the light source module is connected to the third mounting area.

3. The solar fountain nozzle according to claim 2, wherein a detecting terminal configured to detect water flow is disposed on the housing, one end of the detecting terminal is electrically connected to the main control board, and another end of the detecting terminal extends into the water inlet cavity.

4. The solar fountain nozzle according to claim 3, wherein at least two detecting terminals are spaced at intervals between two ends of the water inlet cavity.

5. The solar fountain nozzle according to claim 3, wherein a placement groove is provided at the upper end of the housing, and the solar panel is mounted in the placement groove.

6. The solar fountain nozzle according to claim 5, wherein a wiring hole is further provided at the placement groove, and the solar panel and/or the detecting terminal are/is connected to the main control board by using a conducting wire passing through the wiring hole.

7. The solar fountain nozzle according to claim 2, wherein a sealing cover is disposed at the second end of the accommodating cavity.

8. The solar fountain nozzle according to claim 7, wherein a switch board is connected with the mounting base, the switch board is configured to allow the battery to abut against the first mounting area of the mounting base, and a switch button adaptive to the switch board is disposed on the sealing cover.

9. The solar fountain nozzle according to claim 2, wherein the light source module is a light strip assembly that comprises a lamp bead board and a mounting structure, wherein the lamp bead board is disposed on the mounting structure, and the mounting structure is fastened to the mounting base.

10. A swimming pool fountain, comprising a water supply pipe and the solar fountain nozzle according to claim 1, wherein a connector is disposed on a water inlet of the solar fountain nozzle, the connector is connected to a water outlet end of the water supply pipe, and a water inlet end of the water supply pipe is configured to connect to a drainage port of a swimming pool.
